(19) United States
(12) Patent Application Publication
(10) Pub. No.: US 2014/0091931 A1
(43) Pub. Date: Apr. 3, 2014

(54) Container Monitoring Device with Cable Lock and Remote Sensor Pods

(71) Applicant: Hutchison International Ports Enterprises Limited, Road Town (VG)

(72) Inventors: Nicholas D. Cova, Salt Lake City, UT (US); Ryan Scott Luong Carpenter, Mid-Levels (CN)

(21) Appl. No.: 13/631,063

(22) Filed: Sep. 28, 2012

(51) Int. Cl. G08B 13/12

(52) U.S. Cl. 340/568.2

(57) ABSTRACT

In some implementations, a container monitoring device can include an electrically conductive cable for securing the doors of a shipping container. The container monitoring device can transmit a signal through the cable and detect when the cable has been cut or tampered with based on the transmitted signal. In some implementations, the conductive cable can be reused to secure the doors of the shipping container after the cable has been cut. In some implementations, the container monitoring device can wirelessly communicate with one or more sensor pods located inside the shipping container. The sensor pods can include various environmental sensors configured to take measurements of environmental conditions within the shipping container. The sensor pods can transmit the sensor measurements to the container monitoring device and the container monitoring device can report the sensor measurements to a server for review by a user.

### TECHNICAL FIELD

The disclosure generally relates to securing and monitoring shipping containers.

### BACKGROUND

Shipping containers (i.e., shipping assets) are used to transport goods all over the world. For example, shipping containers can be placed on the back of trucks, on cargo ships, on trains and other vehicles. Because the goods transported in the shipping containers can be valuable, the shipping containers are often secured and/or monitored by various mechanical and electronic devices. These devices can be configured to detect when a shipping container has been opened or tampered with and report the status of the shipping container to users charged with ensuring the shipping containers reach their destinations with their goods intact.

### SUMMARY

In some implementations, a container monitoring device can include an electrically conductive cable for securing the doors of a shipping container. The container monitoring device can transmit a signal through the cable and detect when the cable has been cut or tampered with based on the transmitted signal. In some implementations, the conductive cable can be reused to secure the doors of the shipping container after the cable has been cut.

In some implementations, the container monitoring device can wirelessly communicate with one or more sensor pods located inside the shipping container. The sensor pods can include various environmental sensors configured to take measurements of environmental conditions within the shipping container. The sensor pods can transmit the sensor measurements to the container monitoring device and the container monitoring device can report the sensor measurements to a server for review by a user.

Particular implementations provide at least the following advantages: The conductive cable used for securing the doors of the shipping container can be reused after being cut. The environmental conditions within the shipping container can be monitored using remote sensor pods and alerts or events triggered when the environmental conditions cross configurable threshold values. Monitoring the environmental conditions can prevent goods from being ruined, for example.

Details of one or more implementations are set forth in the accompanying drawings and the description below. Other features, aspects, and potential advantages will be apparent from the description and drawings, and from the claims.

### DESCRIPTION OF DRAWINGS

FIG. 1 illustrates an example system for monitoring shipping containers.

FIG. 2 is a diagram that illustrates a container monitoring device having a cable lock securing the doors of a shipping container.

FIG. 3 is a diagram illustrating sealing a shipping container with the container monitoring device of FIG. 2

FIG. 4 is a diagram illustrating unsealing and resealing a container monitoring device on a shipping container.

FIGS. 5A and 5B are examples of conductive cables that can be used with a container monitoring device to secure a shipping container.

FIG. 6 is a block diagram illustrating capabilities of and interactions between container monitoring devices and sensor pods.

FIG. 7 illustrates a system including a container monitoring device associated with a covert tracking device.

FIG. 8A is a flow diagram of an example process for sealing a shipping container using a container monitoring device having a cable lock.

FIG. 8B is flow diagram of an example process for receiving sensor pod measurements and reporting sensor pod events.

FIG. 8C is flow diagram of an example process for detecting removal of a container monitoring device.

Like reference symbols in the various drawings indicate like elements.

### DETAILED DESCRIPTION

### Example System

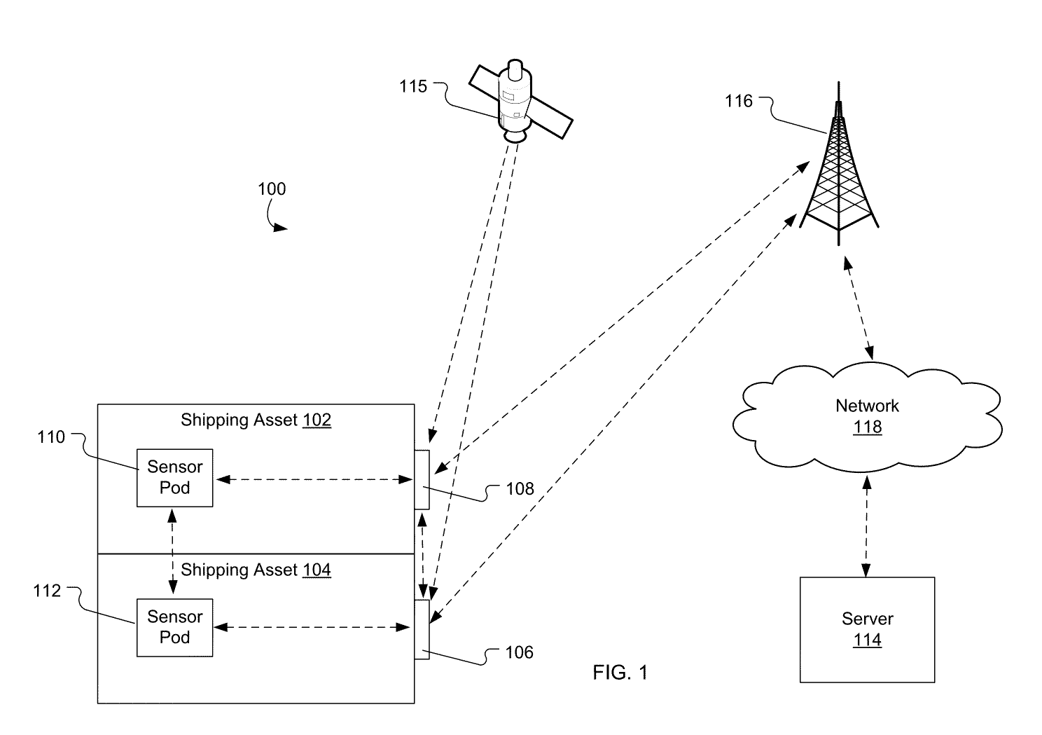

FIG. 1 illustrates an example system 100 for monitoring shipping containers (i.e., shipping assets). System 100 can include shipping assets 102 and 104. For example, a shipping asset can be a cargo container, a dry van container, a refrigerated container or any other container having doors that can be swung open or rolled up. If shipping assets are stackable containers, the shipping assets 102 and 104 can be stacked on top of each other. For example, shipping assets 102 and 104 can be stacked on top of each other when loaded on a boat and transported across the water.

In some implementations, shipping assets 102 and 104 can be secured and monitored by container monitoring devices (CMD) 106 and 108. For example, CMD 106 and CMD 108 can be attached to the doors of shipping asset 102 and 104, respectively. In some implementations, CMD 106 and CMD 108 can be attached to the shipping assets using an electrically conductive cable that can be used to detect when the doors of the asset are opened or tampered with.

In some implementations, CMD 106 and CMD 108 can communicate with sensor pods 110 and 112 to receive information about environmental conditions inside shipping assets 102 and 104. For example, sensor pods 110 and 112 can be configured with light sensors, temperature sensors, humidity sensors and other environmental sensors capable of detecting the environmental conditions inside shipping assets 102 and 104. When the sensor pods 110 and/or 112 detect a change in the environmental conditions inside shipping container 102 or 104, the sensor pods can transmit environmental data describing the change in the internal environment of the shipping assets to CMD 106 and/or CMD 108. For example, if the internal temperature of the shipping container exceeds predefined threshold values, then the sensor pod can transmit the temperature data to CMD 106 or CMD 108. In some implementations, sensor data is transmitted from sensor pods to CMDs on a periodic basis. For example, sensor data can be transmitted from the sensor pods to the CMDs every five minutes.

In some implementations, when CMD 106 or CMD 108 detects an event, the CMD can report the event to server 114. For example, an event can be a change in environmental condition, a detected tampering with the CMD or conductive cable, or an initialization of the CMD. For example, server 114 can be a system configured to receive reports from container monitoring devices and present the reports to a user of the system. The server allows a user to monitor the status of shipping assets 102 and 104.

In some implementations, when CMD 106 or CMD 108 detects an event the CMD can determine the current location of the CMD and the current time based on global positioning satellite information. For example, CMD 106 and CMD 108 can be configured with a global navigation satellite system (GNSS) sensor (e.g., GPS receiver) for receiving signals from GNSS satellite 115. The CMD can then use the satellite signals to determine the current location and current time associated with the detected event.

In some implementations, CMD 106 and/or CMD 108 can transmit the event reports to server 114 using a radio access technology based network. For example, a radio access technology network can be a cellular network, such as a GSM, CDMA, LTE, GPRS or any other data network that utilizes a radio access technology to wirelessly transmit data. For example, CMD 106 and/or 108 can wirelessly transmit the event reports to cellular tower 116. Cellular tower 116 can transmit the event reports over network 118 (e.g., the internet) to server 114 where server 114 can process the event reports and present the event information to a user monitoring the system.

In some implementations, CMD 106 or CMD 108 can transmit event data associated with other CMDs or other sensor pods. For example, if shipping assets 102 and 104 are stacked, as illustrated by FIG. 1, CMD 106 may not have a clear view of satellite 115 or may not be able to communicate with cellular tower 116. In this case, CMD 106, CMD 108 and/or sensor pods 110 and 112 can be configured to create an ad hoc or mesh network for sharing and reporting event information. For example, if CMD 106 cannot connect to cellular tower 116, event data that would normally be transmitted to server 114 by CMD 106 can be transmitted from CMD 106 to CMD 108 and then transmitted by CMD 108 to server 114 through the cellular tower 116. If CMD 106 cannot receive signals from satellite 115 but CMD 108 can, the location and time information received by CMD 108 from satellite 115 can be used to provide location and time information for CMD 106 events. For example, CMD 106 can retrieve location and time information from CMD 108 through the ad hoc or mesh network.

### Securing Container Doors

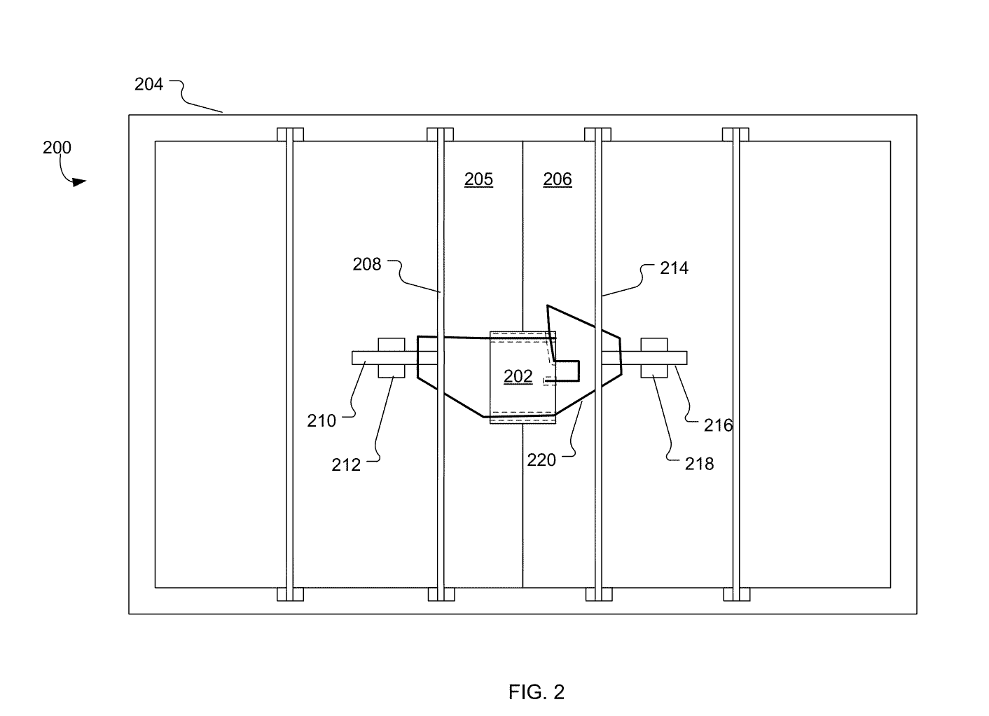

FIG. 2 is a diagram 200 that illustrates a CMD having a cable lock securing the doors of a shipping container. For example, CMD 202 can correspond to CMD 106 and/or CMD 108, described above. Shipping container 204 can have doors for accessing the inside of shipping container 204. For example, shipping container 204 can have one or more doors 205 and 206 that can be opened to access the contents of shipping container 204. Doors 205 and 206 can have fixtures attached to the outside of the doors to secure the doors when closed. For example, doors 205 and 206 can include vertical fixtures 208 and 214 that can engage with fixtures on the shipping container to secure the doors when shut. Vertical fixtures 208 and 214 can be rotated into fixtures on shipping container 204 to secure the doors shut, for example. Vertical fixtures 208 and 214 can include handles 210 and 216 for rotating vertical fixtures 208 and 214. Handles 210 and 216 can be secured to the doors by locking handles 210 and 216 to locking fixtures 212 and 218 to prevent rotating vertical elements 208 and 214, thereby preventing opening doors 204 and 206.

In some implementations, doors 205 and 206 can be secured and monitored by threading cable 220 through CMD 202 and around door fixtures 208, 214, 212 and 218. In some implementations, cable 220 can be a conductive cable that can be used to transmit a signal from CMD 202 to CMD 202. For example, when activated to secure and monitor a shipping container, CMD 202 can transmit a signal from an originating end of the cable and receive the signal at a terminating end of the cable. In some implementations, CMD 202 can detect tampering (e.g., opening) of the shipping container based on the signals transmitted through cable 220. For example, if cable 220 is cut, no signal will be transmitted through cable 220. Thus, if an unexpected interruption or modification of the signal through cable 220 is detected, then CMD 202 can determine that a tampering or unauthorized opening event (e.g., cable breach) has occurred.

### Sealing Container with Conductive Cable

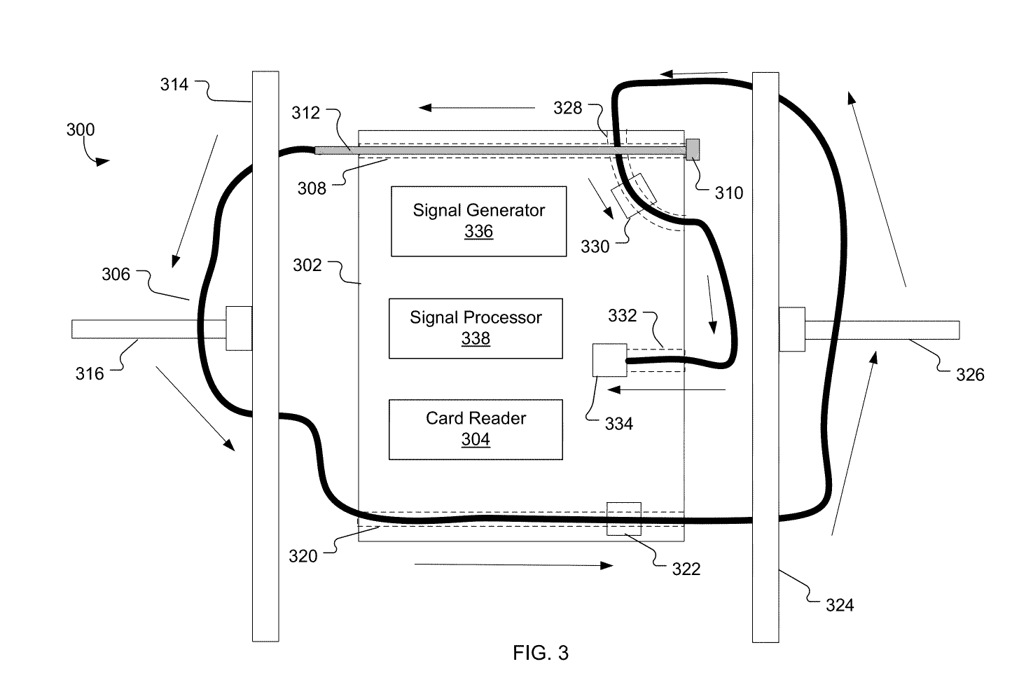

FIG. 3 is a diagram 300 illustrating sealing a shipping container with the CMD of FIG. 2. For example, diagram 300 illustrates threading the conductive cable around door fixtures of the shipping container to secure the shipping container doors. For example, CMD 302 can correspond to CMD 202 of FIG. 2. In some implementations, CMD 302 can be turned on or activated by pressing a power button (not shown). Once activated, the CMD can be used to secure the shipping container using conductive cable 306.

In some implementations, CMD 302 can include a card reader 304. For example, card reader 304 can be a near field communication device configured to communicate with an access card embedded with a near field communication chip (e.g., radio frequency identification (RFID) chip). The card can be used to identify persons authorized to initialize and interact with CMD 302. For example, if card reader 304 detects an access card preceded or followed by an activity, such as CMD activation, deactivation or cable breach (e.g., cutting of cable 306), CMD 302 will register the event as an authorized initialization, deactivation or cable breach instead of an unauthorized cable breach (e.g., tampering) event. This authorization can be done on the CMD itself using an access card that was listed in the server as an authorized access card or on the Server by logging into a webpage and authorizing specific events with a mouse click.

In some implementations, CMD 302 can include conductive cable 306. For example, cable 306 can be threaded through passages within CMD 302 and around fixtures on a shipping container (e.g., shipping container doors) to secure and monitor the doors of the shipping container. For example, CMD 302 and conductive cable 306 can be used to verify that the container doors remain closed and that the CMD remains attached to the shipping container by monitoring signals transmitted through conductive cable 306.

In some implementations, conductive cable 306 can be threaded through CMD cable passage 308. In some implementations, cable 306 can include a rigid bolt like portion 312 at one end of a flexible cable. For example, cable 306 can be threaded through upper cable passage 308 until bolt head 310 is flush against the side of CMD 302. For example, the rigid bolt like portion can be made of a conductive metallic material, such as steel, copper or gold. In some implementations, once cable 306 is threaded through passage 308, cable 306 can be threaded behind the upper portion of vertical door fixture 314 (e.g., vertical fixture 208 or 214), over door handle 316 (e.g., handle 210 or 216) and back under the lower portion of vertical door fixture 314.

In some implementations, conductive cable 306 can be threaded through CMD cable passage 320. For example, after cable 306 is threaded around door fixture 314 and handle 316, then cable 306 can be threaded through lower cable passage 320. In some implementations, passage 320 can include a signal sensor 322. For example, signal sensor 322 can be a Rogowski coil. Signal sensor 322 can be configured to detect current or signal pulses conducted through cable 306. Signal sensor 322 can be used to determine whether cable 306 is threaded through passage 320 upon initialization. Signal sensor 322 can be used to determine whether an unauthorized cable breach has occurred. For example, if cable 306 is threaded through passage 320, a current will be detected in cable 306 by signal sensor 322 when CMD 302 is operational. Later, if the signal sensor 322 detects no current in cable 306, then CMD 302 can determine that a cable breach (e.g., cutting) has occurred. In some implementations, once cable 306 is threaded through passage 320, cable 306 can be threaded behind the lower portion of vertical door fixture 324, over door handle 326 and behind the upper portion of vertical door fixture 324.

In some implementations, conductive cable 306 can be threaded through CMD cable passage 328. For example, after threading cable 306 behind the lower portion of vertical door fixture 324, over door handle 326 and behind the upper portion of vertical door fixture 324, cable 306 can be threaded through passage 328. In some implementations, passage 328 can be configured with signal sensor 330. For example, signal sensor 330 can be a Rogowski coil. Signal sensor 330 can be configured to detect current or signal pulses conducted through cable 306. Signal sensor 330 can be used to determine whether cable 306 is threaded through passage 328 upon initialization of CMD 302. In some implementations, signal sensor 330 can be used to determine whether a cable breach has occurred. For example, if cable 306 is threaded through passage 328, a current will be detected in cable 306 by signal sensor 330 when CMD 302 is operational. Later, if the signal sensor 330 detects no current in cable 306, then CMD 302 can determine that a cable breach (e.g., cutting) has occurred.

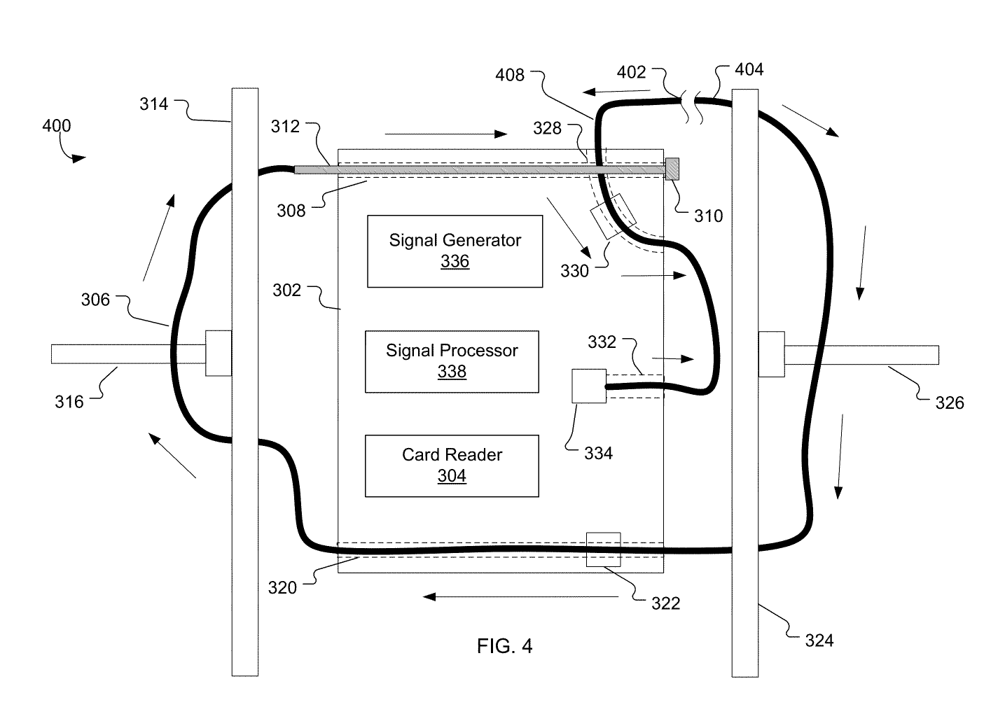

In some implementations, passage 328 can be configured to allow one-way movement of cable 306 through passage 328. For example, cable 306 can be threaded through passage 328 in the direction of the arrows of FIG. 3, but passage 328 can be configured to prevent the cable from being extracted in a direction opposite the arrows. Thus, in some implementations, the only way to remove cable 306 from passage 328 is to cut cable 306 above passage 328, as illustrated by FIG. 4.

In some implementations, cable 306 can be inserted into passage 332 and coupled to connector 334. For example, after threading cable 306 through passage 328, cable 306 can be inserted into passage 322 and the end of cable 306 can be electronically coupled to connector 334. In some implementations, coupling cable 306 to connector 334 can complete an electrical circuit that includes cable 306. For example, signal generator 336 can generate a signal and transmit the signal through cable 306 starting at passage 308. Signal generator 336 can be electronically coupled to cable 306 at passage 308 (e.g., the originating end of the cable 306). The signal can be propagated along cable 306 until the signal reaches connector 334 (e.g., the terminating end of cable 306). Connector 334 can receive the signal and transmit the signal to signal processor 338. In some implementations, passage 332 can be configured to secure cable 306 in passage 332. For example, passage 332 can include a mechanism that will not release cable 306 in the passage for removal until a button or some other release mechanism is activated by the user. For example, a user will not be able to remove cable 306 from passage 332 until a button is pressed.

In some implementations, signal processor 338 can analyze the signal received at connector 334 to determine if cable 306 has been tampered with. For example, signal processor 338 can compare the signal received at connector 334 to the signal generated by signal generator 336 to determine if there are any variations in the waveform of the signal that might indicate cutting, bypassing, stretching, or other types of tampering with cable 306.

In some implementations, signal processor 338 can analyze signals that have been reflected or bounced back along cable 306 to passage 308. For example, if cable 306 has been cut (e.g., cut and bypassed), the cut end of the cable can cause the transmitted signal to be reflected back along cable 306. Signal processor 338 can be configured to detect the reflected signals attributed to a cut cable.

In some implementations, a signal generator 336 can initiate a waveform at the originating end of the cable and simultaneously send the same waveform along a conductive pathway that is internal to the CMD housing. For example, at initialization of the CMD, the signal processor 338 can analyze the delta (e.g., difference) between the internal conductive pathway and the external cable. The signal processor can monitor the phase and/or gain delta for each signal, for example. The signal processor can compare the signal received at the terminating end of the cable to the signal received from the internal conductive pathway to determine a change in the signal through the cable. Tampering with the external cable can cause a change in the phase and/or gain delta measured by the signal processor 338, which would determine that a tamper event occurred.

In some implementations, the CMD can compare the waveform of a signal received at the terminating end of the cable to a waveform baseline to determine whether tampering has occurred. For example, signal generator 336 can initiate a waveform at the originating end of the cable. At initialization of the CMD, the signal processor 338 can take a snapshot (e.g., baseline) of the waveform (e.g. the phase and gain) at the terminating end of the cable. The signal processor can monitor for any changes to the baseline. For example, the signal processor can compare the waveform baseline to the waveform of the signal received later at the terminal end of the cable to detect changes in the waveform received from the cable. Tampering with the external cable can cause a change in the phase and/or gain delta (e.g., difference) between the baseline and the current waveform measured by the signal processor 338, which would indicate that a tamper event has occurred.

In some implementations, signal processor 338 can analyze the electrical properties (e.g. impedance, conductance, capacitance, etc.) of cable 306 to determine whether it has been tampered with. For example, at initialization of the CMD, signal processor 338 can take a snapshot (e.g., baseline) of the electrical properties of the cable. Signal processor 338 can monitor for any changes to that baseline. For example, the signal processor can compare the electrical properties baseline to the electrical properties measured periodically after initialization to detect changes to the electrical properties of the cable. Tampering with the external cable can cause a change in the electrical properties measured by the signal processor 338, which would indicate that a tamper event occurred.

In some implementations, signal processor 338 can analyze the radiated properties (e.g. magnetic field, magnetic flux, Lorentz force, Laplace force, electromagnetic radiation, etc.) from the cable 306 to determine whether it has been tampered with. For example, at initialization of the CMD, signal processor 338 can take a snapshot (e.g., baseline) of the radiated properties from the cable. The signal processor can monitor for any changes to that baseline. For example, the signal processor can compare the radiated properties baseline measurements to measurements of the radiated properties of the cable taken periodically after initialization to detect changes in the radiated properties of the cable. Tampering with the external cable can cause a change in the radiated properties measured by the signal processor 338, which would indicate that a tamper event occurred.

In some implementations the cable could have a conductive core, as well as a conductive sheath that is electrically insulated from the conductive core. In this case, any of the aforementioned tamper detection mechanisms could be applied to both the inner conductive core and independently to the conductive sheath thereby creating a layered and redundant approach to detecting tampers and to prevent bypassing the tampering detection system. In some implementations, the CMD could use a mix-and-match of any of the aforementioned tamper detection mechanisms to create a layered and redundant approach to detecting tampers and to prevent bypassing the detection system.

In some implementations, CMD 302 can detect authorized or unauthorized events based on input to card reader 304. For example, if card reader 304 detects an access card prior to a cable breach, then the cable breach can be identified as an authorized cable breach event. If card reader 304 does not detect an access card prior to a cable breach, then the cable breach can be identified as an unauthorized cable breach event. For example, the cable breach event can be determined locally by the CMD, or centrally at the server.

### Reusable Conductive Cable for Resealing Container

FIG. 4 is a diagram 400 illustrating unsealing and resealing a CMD on a shipping container. In some implementations, conductive cable 306 can be cut and reused. For example, during inspection of a shipping container it may be necessary to cut cable 306 above passage 328 (e.g., at location 402) in order to access the inside of the shipping container. However, the shipping container may not yet be at its destination. Accordingly, the shipping container may need to be resealed using CMD 302 and cable 306. Thus, in some implementations, cable 306 can be cut and the freshly cut and reusable portion 404 of cable 306 can be coupled to connector 334 to secure the shipping container. In some implementations, the cut off portion 408 of cable 306 can be removed by pulling the cable through the lower end of passage 328 and releasing the cable from passage 332, as described above.

In some implementations, when the shipping container is not to be resealed, cable 306 can be cut, as described above, and removed from CMD 302 by pulling the cut off portion 408 cable 306 through the lower end of passage 328 and releasing the cable from passage 332, as described above. The reusable portion 404 of cable 306 can be unthreaded from CMD 302 and from shipping container fixtures 326, 324, 316 and 314, as indicated by the arrows of FIG. 4.

In some implementations, CMD 302 can detect authorized and unauthorized unsealing and sealing of the shipping container. For example, if card reader 304 detects an access card prior to cutting cable 306, then an authorized unsealing (e.g., cable breach) can be detected. If card reader 304 does not detect an access card prior to cutting cable 306, then an unauthorized unsealing or cable breach can be detected. In some implementations, authorized and unauthorized cable breaches can be reported to the monitoring server, as described above with reference to FIG. 1.

### Example Conductive Cables

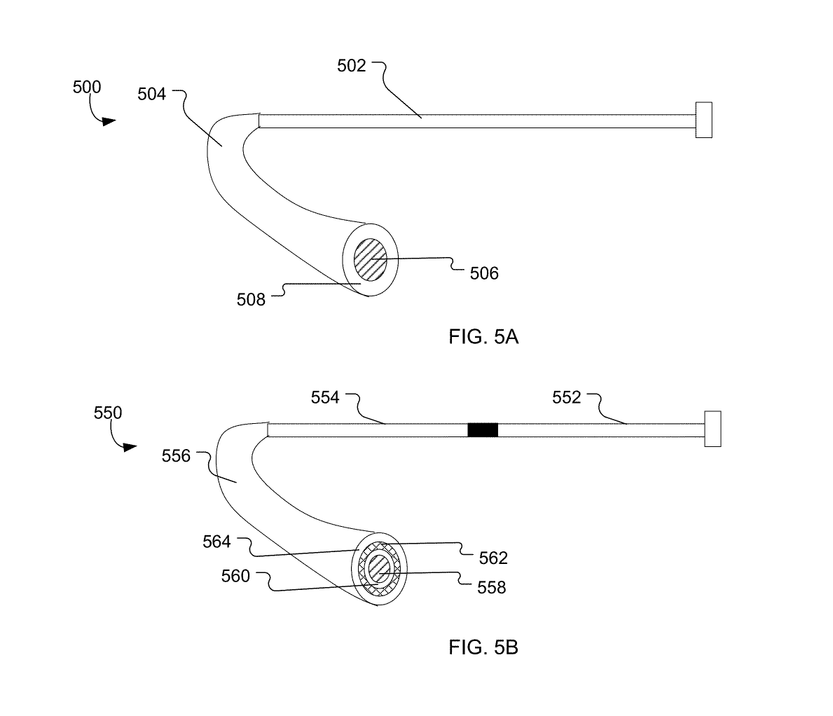

FIGS. 5A and 5B are examples of cables 500 and 550 that can be used with a CMD to secure a shipping container. FIG. 5A illustrates a cable 500 with a single conductive core. For example, cable 500 can have a rigid (e.g., bolt like) portion 502 and a flexible portion 504. Rigid portion 502 can be a solid metallic conductive material, for example. Flexible portion 506 can include a conductive core 506 covered in an electrical insulation material 508. Conductive core 506 can be coupled to rigid portion 502 so that an electronic signal or electrical current applied at rigid portion 502 can be transmitted along the cable through conductive core 506. For example, rigid portion 502 can be the originating end of cable 500 such that when signal generator 336 of FIG. 3 is electrically coupled to rigid portion 502, signal generator 336 can transmit a signal through cable 500 starting at rigid portion 502 and ending at the end of conductive core 506. For example, the end of conductive core 506 (e.g., the terminating end) can be coupled to connector 334 of FIG. 3 to complete an electronic circuit through cable 500.

FIG. 5B illustrates a cable 550 having multiple conductive cores. For example, using a cable with multiple conductive cores may make it more difficult for someone to cut and bypass cable 550 because the bypass would have to include all of the conductive cores. In some implementations, cable 550 can include rigid portions 552 and 554 and flexible portion 556. For example, rigid portions 552 and 554 can be a solid metallic conductive material. In some implementations, flexible portion 556 can include two or more conductive cores. For example, flexible portion 556 can include conductive core 558 and conductive core 562. Conductive cores 558 and 562 can be electrically insulated from each other by insulating layer 560 and insulated by insulating layer 564.

In some implementations, cable 550 can be used to transmit multiple signals. For example, rigid portion 552 can be coupled to conductive core 558. Rigid portion 554 can be coupled to conductive core 562. In some implementations, signal generator 336 of FIG. 3 can be configured to transmit multiple signals through cable 550. For example, signal generator 336 can be coupled to rigid portion 552 and transmit a signal having a first waveform through conductive core 558. Signal generator 336 can be coupled to rigid portion 554 and transmit a signal having a second waveform through conductive core 562. Similarly, connector 334 can be configured to couple to both conductive core 558 and conductive core 562 and receive the two signals transmitted through the conductive cores. The two signals can then be processed by signal processor 338 to determine if the waveforms of the two signals have been modified from the original waveforms transmitted by signal generator 336.

### Container Monitoring Device and Sensor Pods

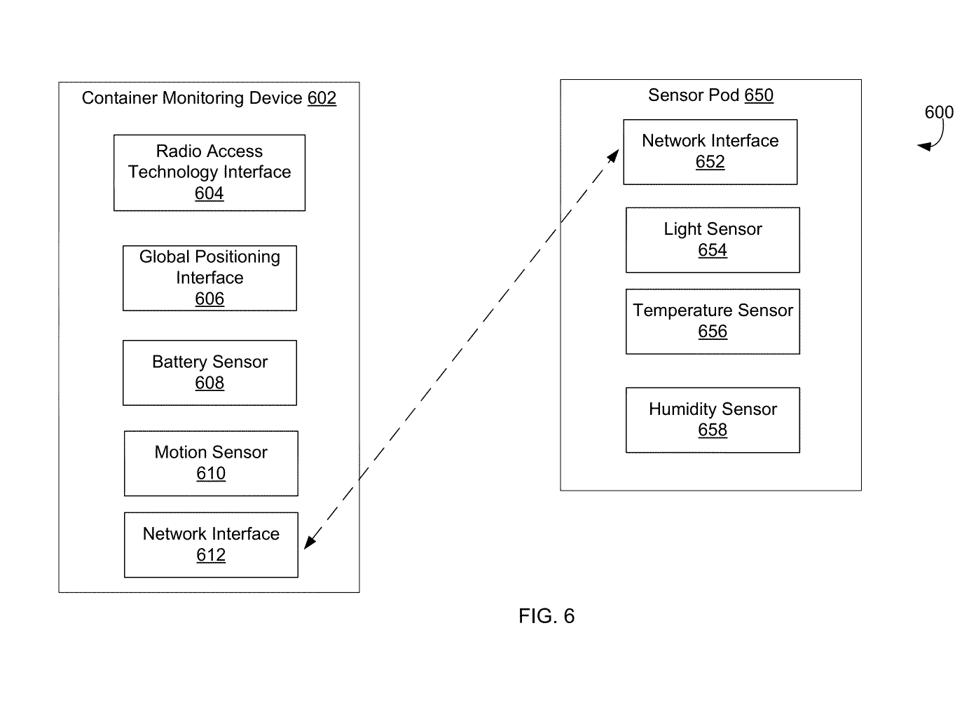

FIG. 6 is a block diagram 600 illustrating capabilities of and interactions between container monitoring devices and sensor pods. In some implementations, CMD 602 can include a radio access technology (RAT) interface 604. For example, RAT interface 604 can be configured to communicate with a cellular data network (e.g., a general packet radio service (GPRS)), such as GSM, CDMA, LTE or any other cellular data network. In some implementations, the RAT interface 604 can transmit or report status and/or event information to a monitoring server (e.g., server 114 of FIG. 1). For example, event information, such as CMD activation events, cable breach events, CMD deactivation events and sensor pod events can be transmitted to the monitoring server, as described with reference to FIG. 1

In some implementations, if RAT interface 604 cannot access the GPRS network layer of the cellular data network, then status or event information can be transmitted to the server using short messaging service (SMS) messaging. For example, SMS messages can include the event type, timestamp and current geographic coordinates and any other pertinent data that can be compressed into an SMS formatted message. In some implementations, once a GPRS connection is established, previously sent SMS reporting messages can be retransmitted using GPRS messages.

In some implementations, CMD 602 can include global positioning interface 606. For example, global positioning interface 606 can receive signals from global positioning satellites (e.g., GPS, GLONASS, or other global navigation satellite system). The signals can include positioning and time information that CMD 602 can use to determine its current geographic location and current time. In some implementations, the current geographic location and current time can be determined for each detected event and included in messages reporting each event. Thus, the server can determine the time and location associated with each event.

In some implementations, CMD 602 can include battery sensor 608. For example, battery sensor 608 can determine the charge remaining on the batteries powering CMD 602. In some implementations, when battery sensor 608 determines that the battery or batteries are below a threshold charge, a low battery event can be generated and reported to the monitoring server.

In some implementations, CMD 602 can include motion sensor 610. For example, motion sensor 610 can be an accelerometer or other motion sensing device. In some implementations, motion sensor 610 can monitor the movement of CMD 602. For example, when CMD 602 is active and attached to a container being transported on a vehicle (e.g., truck, train, ship, etc.), motion sensor 610 can detect when the vehicle starts moving, stops moving and/or changes directions. In some implementations, when motion sensor 610 detects a change in movement (e.g., acceleration that exceeds a configured threshold value), a motion event can be generated by CMD 602. For example, the motion event can be reported to the monitoring server through RAT interface 604.

In some implementations, CMD 602 can include network interface 612. For example, network interface 612 can include a device for establishing short range radio communication with other container monitoring devices and sensor pods. For example, network interface 612 can be implemented using Bluetooth, ZigBee, or any other wireless networking protocol.

In some implementations, network interface 612 can be used to create a mesh network between container monitoring devices and sensor pods. For example, if a CMD cannot access RAT (e.g., cellular) networks or cannot receive GPS signals, the CMD can communicate through other sensor pods and other CMDs to gain access to the networks and/or GPS data, as described with reference to FIG. 1.

In some implementations, network interface 612 can be used to communicate with sensor pod 650. For example, sensor pod 650 can include network interface 652 that can be used to communicate data to CMD 602 through network interface 612. In some implementations, CMD 602 can detect, using network interface 612, sensor pods (e.g., sensor pod 650) that are proximate to CMD 602. Sensor pods that are within a predefined distance (e.g., based on wireless signal strength) of CMD 602 can be associated with CMD 602, for example. Once associated with CMD 602, sensor pod 650 can transmit sensor event information to CMD 602 so that CMD 602 can report the sensor event information to the monitoring server.

### Example Sensor Pod Configuration

In some implementation, sensor pod 650 can be used to monitor environmental conditions within a shipping container and report environmental events to CMD 602. CMD 602 can then report the environmental events to the monitoring server. In some implementations, sensor pod 650 can include a light sensor 654. For example, sensor pod 650 can include a photodetector for monitoring light intensity within a shipping container. For example, when the light intensity detected by the photodetector crosses a threshold intensity value, a light intensity event can be transmitted to the CMD and reported to the monitoring server.

In some implementations, sensor pod 650 can include a temperature sensor 656. For example, temperature sensor 656 can be a thermometer on sensor pod 650 or a thermometer attached to a sensor probe in communication with sensor pod 650. In some implementations, sensor pod 650 can report the detected temperature within the shipping container to CMD 602. CMD 602 can then generate events based on the detected temperature. For example, when the temperature value crosses a threshold value (e.g., a temperature limit value, a high temperature warning value, a low temperature warning value, a low temperature limit value, etc.), then the CMD can generate a corresponding temperature event and report the temperature event to the monitoring server.

In some implementations, sensor pod 650 can include humidity sensor 658. For example, humidity sensor 658 can be a hygrometer installed on sensor pod 650. In some implementations, humidity sensor 658 can measure the humidity inside a shipping container and report the humidity measurements to CMD 602. CMD 602 can compare the humidity measurements to one or more humidity threshold values (e.g., a high humidity limit value, a high humidity warning value, a low humidity warning value and/or a low humidity limit value) and generate a humidity event based when the humidity measurement crosses (e.g., becomes greater than, becomes less than) one of the humidity threshold values.

In some implementations, multiple sensor pods can be used to determine when a humidity threshold value has been crossed. For example, a humidity event can be generated when some or all of the sensor pods within a shipping container are reporting the same humidity measurement and the humidity measurement crosses a humidity threshold value. In some implementations, a humidity event will be generated once the humidity crosses a humidity threshold value for a period of time. For example, a humidity event can be generated after the humidity within the shipping container is greater than a threshold value for five minutes. If the humidity temporarily exceeds the threshold humidity value for less than the specified period of time (e.g., less than five minutes), then no humidity event will be generated.

In some implementations, sensor pod 650 can include an accelerometer, battery sensor and/or an air pressure sensor. For example, measurements from the accelerometer, battery sensor, and/or air pressure sensor can be transmitted to CMD 602 and reported to the monitoring server as events. For example, when the measurements cross predetermined threshold values, accelerometer, battery sensor and/or air pressure events can be generated and reported to the monitoring server, as describe herein.

### Container Monitoring Device and Covert Tracking Device

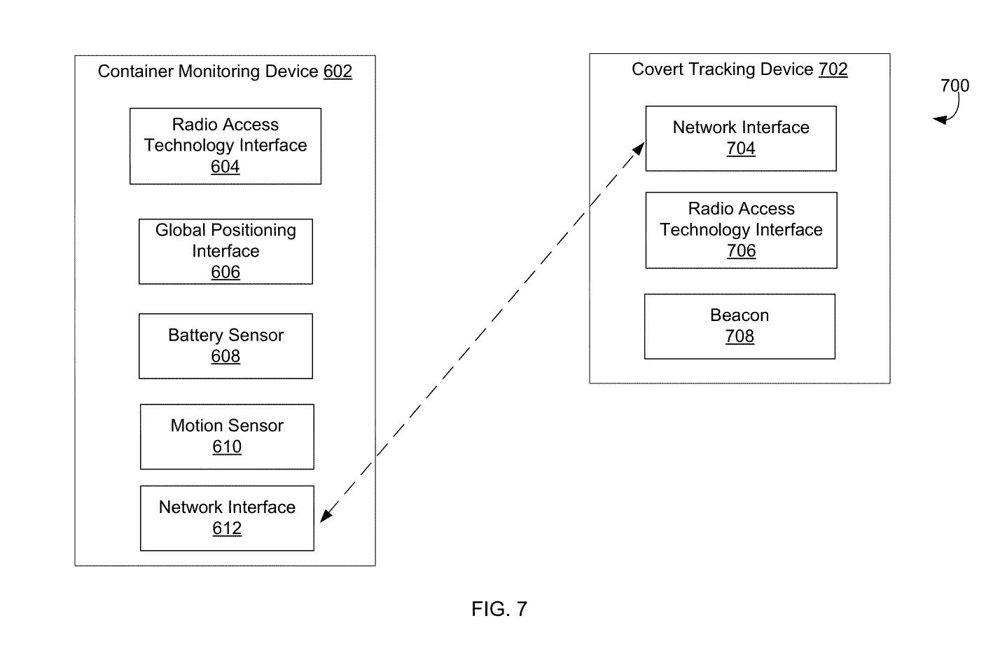

FIG. 7 illustrates a system 700 including a container monitoring device associated with (e.g., tethered to) a covert tracking device. For example, similar to the sensor pods described above, the covert tracking device (CTD) 702 can be placed inside a shipping container and configured to communicate with a CMD 602 affixed to the outside of the shipping container. In some implementations, CTD 702 can include the features and capabilities of sensor pod 650 and/or CMD 602. In some implementations, CTD 702 can detect when CTD 702 can no longer communicate with CMD 602. For example, CTD 702 can operate in a low power mode most of the time and periodically (e.g., every minute) determine the state of the connection with CMD 602. When CTD 702 determines that it can no longer communicate with CMD 602, CTD 702 can report to the server that CMD 602 is no longer available (e.g., the tether is broken). In some implementations, when CMD 602 is no longer available, CTD 702 can take over the functions of CMD 602. For example, CTD 702 can be configured with similar functionality of CMD 602 and can perform the process and functions of the container monitoring devices described herein.

In some implementations, CTD 702 can include network interface 704. For example, network interface 704 can include a device for establishing short range radio communication with other container monitoring devices and sensor pods. For example, network interface 704 can be implemented using Bluetooth, ZigBee, or any other wireless networking protocol.

In some implementations, network interface 704 can be used to create a mesh network between container monitoring devices, sensor pods and covert tracking devices. For example, if a CMD cannot access RAT (e.g., cellular) networks or cannot receive GPS signals, the CMD can communicate through other sensor pods and other CMDs to gain access to the networks and/or GPS data, as described with reference to FIG. 1

In some implementations, network interface 704 can be used to electronically tether CTD 702 to CMD 602. For example, because of the short range of the signal transmitted by network interface 704 and network interface 612, CMD 602 and CTD 702 can detect when CMD 602 and CTD 702 are moved away from each other by detecting when CMD 602 and CTD 702 are no longer able to communicate with each other. For example, if CMD 602 and CTD 702 are communicating through network interface 612 and network interface 704, and if the range of network interface 704 and network interface 612 is six feet, then if CMD 602 or CTD 702 are moved such that the distance between devices is greater than six feet, the devices will not be able to communicate anymore and the electronic tether between the devices will be broken.

In some implementations, when the electronic tether between CMD 602 and CTD 702 is broken, CTD 702 can start reporting events using radio access technology (RAT) interface 706. For example, RAT interface 706 can have the same features and functionality as RAT interface 604 described above. In some implementations, when the tether is broken CTD 702 can be awakened from a low power mode and can start collecting location data (e.g., GPS data, cell tower data, etc.) and send it to the server over the RAT interface in order to track stolen goods. In some implementations, CTD 702 can use RAT interface 706 to report that CMD 602 is missing, untethered or that a breach has occurred.

In some implementations, CTD 702 can include beacon 708. For example, beacon 708 can be configured to emit a signal when CMD 602 becomes untethered. The signal can be used to identify the shipping container and/or cargo and can be tracked to aid in the recovery of the shipping container and/or cargo. For example, beacon 708 can be used in conjunction with a handheld or car-dashboard-mounted radio receiver. The beacon can transmit a high power signal in a specific radio band. The receiver can measure how strong the beacon signal is to determine the distance and/or direction of the beacon from the receiver. For example, a user can move around with the receiver and use the signal strength in different locations to determine the direction of the CTD. If the signal strength increases as the user moves, the user would continue in the direction of increasing strength to find the CTD. If the signal strength decreases, the user would continue moving around until the signal strength starts to increase. Eventually, the increasing signal strength would lead the user to the CTD.

### Reporting Events

In some implementations, events can be reported from CMD 602 to the monitoring server on a regular or periodic basis (e.g., a heartbeat, every ten minutes, etc.). In some implementations, events can be reported from CMD 602 to the monitoring server in response to a detected event. In some implementations, each event report can include the time when the event occurred and the location of CMD 602 when the event occurred and/or sensor measurements, if any. In some implementations, detection of an event can cause CMD 602 to collect event data and/or report events at an accelerated rate. For example, detection of an acceleration event, humidity event, temperature event, light event, etc., can cause CMD 602 to collect event data (e.g., sensor measurements) and report events at a rate (e.g., every one minute) that is faster that the default reporting period for a period of time (e.g., five minutes). In some implementations, sensor measurements received from a sensor pod can include a timestamp indicating when the sensor measurement was taken and a duration indicating how long the sensor measurement was observed (e.g., how long the temperature was at a detected value).

### Generating Events

In some implementations, CMD 602 can generate an activation event. For example, an activation event can be generated when the user turns on CMD 602 (e.g., presses the power button or switch when CMD 602 is not active or turned off).

In some implementations, CMD 602 can generate a cable secured event. For example, when CMD 602 determines that the conductive cable described above has been secured at both ends (e.g., has completed a circuit) and is transmitting signals, then CMD 602 can generate a cable secured event.

In some implementation, CMD 602 can generate a cable breached event. For example, a cable breached event can be generated when the conductive cable described above is cut. The cable breached event can be generated in response to a Rogowski coil detecting that current is no longer being passed through the conductive cable, for example.

In some implementations, the cable breached event can be generated when a change is detected in the waveform of the signal that is being transmitted through the cable. For example, the signal waveform can be modified when the conductive cable is cut, stretched, or otherwise molested. In some implementations, the cable breached event can be generated when a reflected signal is detected. For example, when the conductive cable is cut and bypassed, a signal transmitted through the cable can be reflected off the cut end and back to the signal originating end of the conductive cable.

In some implementations, the cable breached event can indicate whether the cable breach is authorized or unauthorized. For example, if the cable breach event is generated following the scanning of an authorized access card, then an authorized breach event can be generated. In some implementations, authorization to breach the cable can be received by CMD 602 from the monitoring server.

In some implementations, the conductive cable can be reused and re-secured to CMD 602 after the cable has been cut. For example, following an authorized cable breach, the end of the conductive cable can be reattached to CMD 602 thereby completing the circuit and allowing signals to be transmitted through the cable. Once the cable is re-secured, a cable secured event can be generated.

In some implementations, an acceleration event can be generated by CMD 602. For example, the motion sensor on CMD 602 can detect or measure the motion of CMD 602 (e.g., the motion of the container to which CMD 602 is attached). If the motion measurement (e.g., acceleration measurement) exceeds an acceleration threshold value, then an acceleration event can be generated by CMD 602. The acceleration event can include the acceleration measurement, for example.

In some implementations, a temperature event can be generated by CMD 602. For example, CMD 602 can receive temperature measurements from one or more sensor pods within the shipping container. CMD 602 can analyze the temperature measurements to determine if the temperature inside the shipping container crosses (e.g., is greater than, is less than) a threshold temperature value (e.g., high temperature limit, high temperature warning, low temperature warning, low temperature limit). If the temperature measurements indicate that the temperature inside the shipping container crosses a threshold temperature value, a temperature event can be generated by CMD 602. In some implementations, a temperature event will be generated when all sensor pods within a shipping container report the same or similar temperature measurements. In some implementations, a temperature event can include a measurement indicating how long (e.g., the amount of time) the temperature inside the shipping container was above or below a threshold temperature value.

In some implementations, a humidity event can be generated by CMD 602. For example, CMD 602 can receive humidity measurements from one or more sensor pods within the shipping container. CMD 602 can analyze the humidity measurements to determine if the humidity inside the shipping container crosses (e.g., is greater than, is less than) a threshold humidity value (e.g., high humidity limit, high humidity warning, low humidity warning, low humidity limit). When CMD 602 determines that a humidity measurement has crossed a threshold humidity value, a humidity event can be generated by CMD 602. In some implementations, a humidity event will be generated when all sensor pods within a shipping container report the same or similar humidity measurements that cross a humidity threshold value. In some implementations, a humidity event can include a measurement indicating how long (e.g., the amount of time) the humidity inside the shipping container was above or below a humidity threshold value.

In some implementations, a light intensity event can be generated by CMD 602. For example, CMD 602 can receive light intensity measurements from one or more sensor pods. In some implementations, when the light intensity measurement crosses (e.g., is greater than, is less than) a light intensity threshold value, a light intensity event can be generated by CMD 602.

In some implementations, a deactivation request event can be generated by CMD 602. For example, a deactivation request event can be generated when a user presses the power button or switch on CMD 602. In some implementations, CMD 602 will not deactivate until the monitoring server authorizes the deactivation. For example, the monitoring server can preauthorize deactivation based on location or can respond to a deactivation request event by authorizing the deactivation. In some implementations, deactivation of CMD 602 can be authorized based on scanning an access card (e.g., RFID card) and without receiving authorization from the server. For example, if a user wishes to deactivate CMD 602 and the user has an access card, the user can present the access card to CMD 602 so that CMD 602 can scan the access card. Once the access card is scanned and the power button is pressed, CMD 602 can be deactivated.

In some implementations, a forced deactivation event can be generated by CMD 602. For example, a user can force CMD 602 to deactivate by pressing the CMD power button in a specific manner (e.g., a repeated number of times, a specific pattern, pressing the button for a period of time, etc.). When a user forces CMD 602 to deactivate, CMD 602 will not wait for authorization from the server before deactivating. For example, a forced deactivation may be required when the CMD 602 does not have a connection with the server and cannot receive authorization from the server to deactivate. In some implementations, a forced deactivation event will be send to the server when a connection to the server can be established and will include all unreported event data received and/or generated by CMD 602. For example, if the forced deactivation event occurs between event reporting periods (e.g., heartbeats), then an attempt can be made to report all unreported event data to the monitoring server when the forced deactivation event is generated.

In some implementations, a sensor pod association event can be generated by CMD 602. For example, a sensor pod can be associated with CMD 602 using the NFC card reader. When a user wishes to associate a sensor pod with CMD 602, the user can move the sensor pod to within a specified distance (e.g., six centimeters) of CMD 602. CMD 602 can scan a NFC or RFID chip installed in the sensor pod to determine the identity of the sensor pod and associate the sensor pod to CMD 602. Thereafter, CMD 602 and the associated sensor pod can communicate using an ad hoc or mesh network to communicate sensor data. Once the sensor pod is associated with CMD 602, CMD 602 can generate a sensor pod association event. For example, the sensor pod association event can include the sensor pod identifier.

In some implementations, sensor pod association can be performed automatically by CMD 602. For example, CMD 602 can use a Bluetooth, ZigBee or other network interface to detect sensor pods that are proximate to CMD 602 and that have compatible network interfaces. If the detected sensor pods are not already associated with another CMD, CMD 602 can be associated with the detected sensor pods. For example, CMD 602 can obtain the identifiers of the associated sensor pods and record the identifier in a list of sensor pods that are associated with CMD 602.

In some implementations, a sensor pod disassociation event can be generated by CMD 602. For example, when a user wishes to disassociate an associated sensor pod from CMD 602, the user can move the sensor pod to within a specified distance (e.g., six centimeters) of CMD 602. CMD 602 can scan a NFC or RFID chip installed in the sensor pod to determine the identity of the sensor pod and disassociate the sensor pod from CMD 602. In some implementations, the sensor pod can be disassociated from CMD 602 when the sensor pod is held within the specified distance from CMD 602 for a period of time (e.g., ten seconds).

In some implementations, a sensor pod forgotten event can be generated by CMD 602. For example, if a sensor pod has been associated with CMD 602 but is no longer reachable on the ad hoc or mesh network and has not been disassociated from CMD 602, a sensor pod forgotten even can be generated by CMD 602. For example, the sensor pod forgotten event can be generated when the sensor pod and CMD 602 have been moved away from each other farther than a configured or predefined distance or beyond the range of the wireless ad hoc or mesh network signal. The sensor pod forgotten event can include a list of sensor pod identifiers associated with the sensor pods that are no longer reachable.

In some implementations, a CMD untethered event can be generated by CTD 702. For example, when CMD 602 stops communicating with CTD 702, CTD 702 can generate a CMD untethered event and transmit the untethered event to the monitoring server.

### Example Processes

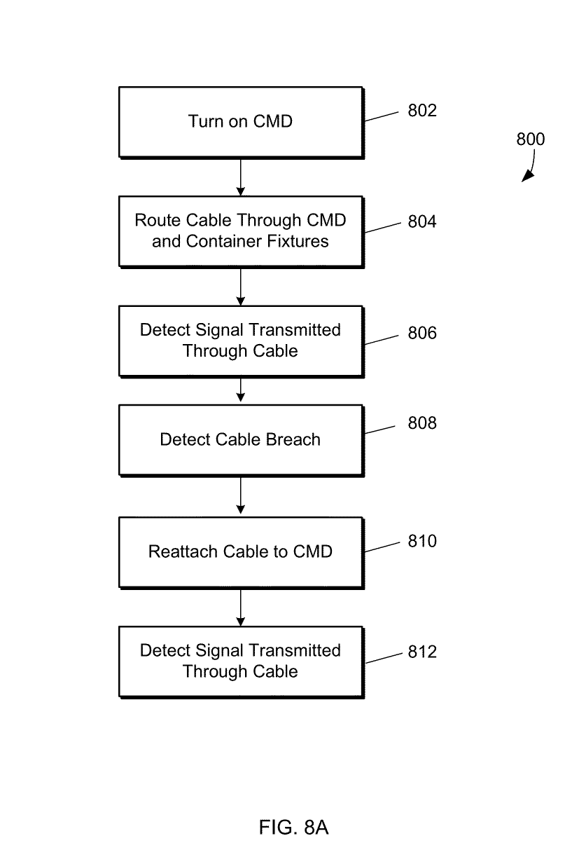

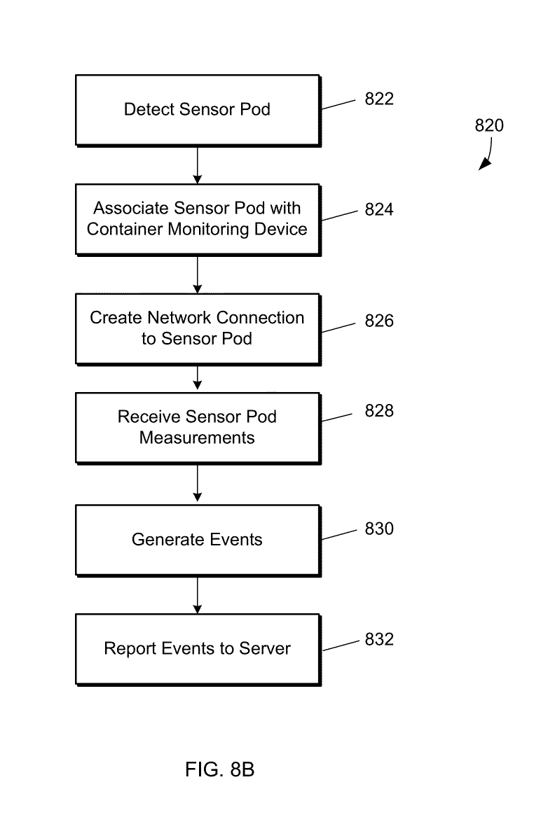

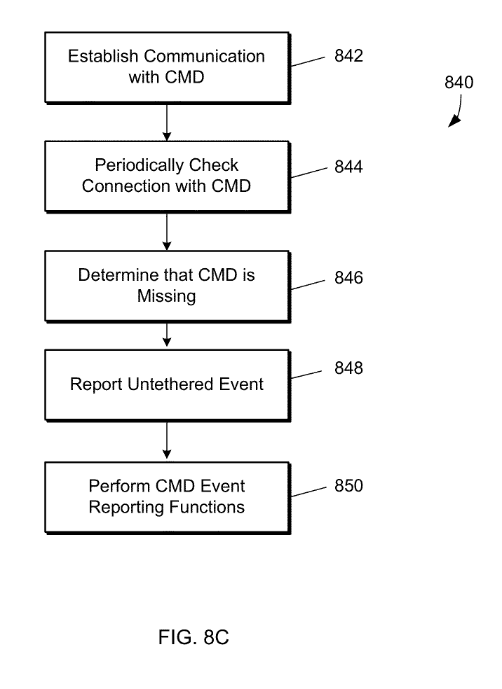

FIG. 8A is a flow diagram of an example process 800 for sealing a shipping container using a container monitoring device (CMD) having a cable lock. At step 802, a user can turn on or activate the CMD. For example, the user can press a power button or switch to activate the CMD.

At step 804, the user can route a conductive cable through passages in the CMD and around shipping container fixtures. For example, the conductive cable can be routed or threaded around fixtures attached to the doors of the shipping container to prevent opening the shipping container doors without cutting, stretching, removing or otherwise molesting the conductive cable.

At step 806, the CMD can detect a signal transmitted through the conductive cable. For example, the CMD can generate and transmit an electronic signal through the conductive cable. The signal can have specific properties (e.g., a specific waveform) that are generated by the CMD. The signal can be transmitted through the cable, received by the CMD and analyzed to determine if the properties (e.g., waveform) of the signal has been modified during transmission through the cable.

At step 808, the CMD can detect a cable breach. For example, if the properties (e.g., waveform) of the signal transmitted through the cable are changed or are different than the signal generated by the CMD, a cable breach can be detected. In some implementations, one or more Rogowski coils can be used to detect a cable breach. For example, when the CMD is activated, the Rogowski coils can detect the signal or an electric current through the cable. If at a later time the Rogowski coils do not detect the signal or the electric current through the cable (e.g., the cable has been cut, the circuit through the cable is open), then a cable breach can be detected. In some implementations, the CMD can detect a cable breach by detecting a signal reflected from a cut in the conductive cable. For example, if the cable is cut and bypassed, a signal transmitted through the cut cable can be reflected back from the cut to the end of the cable where the signal originated.

At step 810, the cut cable can be reattached to the CMD. For example, if the cable has been cut (e.g., an authorized cable breach) to perform an authorized inspection of the contents but the shipping container has not yet reached its destination, the shipping container may need to be resealed. Thus, in some implementations, the conductive cable can be reused after being cut by coupling the cut end of the cable to the CMD, as described above.

At step 812, the CMD can detect a signal transmitted through the conductive cable once the cut cable is reattached to the CMD. For example, once the CMD detects the signal through the cut cable, the CMD can determine that the container has been resealed.

FIG. 8B is flow diagram of an example process 820 for receiving sensor pod measurements and reporting sensor pod events. At step 822, the CMD can detect a sensor pod. For example, the CMD can use NFC, RFID, ad hoc and/or mesh network interfaces to detect a sensor pod in proximity to the CMD.

At step 824, the CMD can associate the detected sensor pod with the CMD. For example, the CMD can receive the sensor pod's identifier and store the identifier in a list of associated sensor pods. At step 826, the CMD can create an ad hoc or mesh network that connects the associated sensor pod to the CMD. The network connection can be used to request sensor measurements from the sensor pod and receive the sensor measurements at the CMD, at step 828.

At step 830, the CMD can generate events based on the received sensor pod measurements. For example, the CMD can compare the sensor pod measurements to threshold values to determine whether to generate and report a sensor event. For example, if temperature, humidity, light intensity or other sensor readings cross configured threshold values, then the CMD can generate events that include the sensor measurements, timestamps that indicate when the event occurred, and location information indicating where the event occurred. At step 832, the sensor events can be reported to the monitoring server so that the events can be reviewed and managed by a user.

FIG. 8C is flow diagram of an example process 840 for detecting removal of a container monitoring device. At step 842, communication is established between a covert tracking device (CTD) and a container monitoring device (CMD). For example, the CTD and the CMD can communicate using network interfaces configured on each device, as described above.

At step 844, the CTD can periodically check the communication connection with the CMD. For example, the CTD can operate in a low power mode and periodically power up to check the state of the network connection with the CMD. The CTD can send a message or a signal to the CMD over the network interface, for example. If the CTD receives a response, the connection is good. If the CTD does not receive a response from the CMD, then at step 846, the CTD can determine that the CMD is missing and report a CMD untethered event to the monitoring server at step 848.

At step 850, the CTD can perform the event reporting functions of the CMD. For example, if the CMD is untethered from the CTD, the CTD can start performing the functions of the CMD, as described above.

A number of implementations have been described. Nevertheless, it will be understood that various modifications may be made. For example, other steps may be provided, or steps may be eliminated, from the described flows, and other components may be added to, or removed from, the described systems. For example, the container monitoring device described herein can be used to secure objects other than shipping containers. For example, the container monitoring device described herein can be used to secure valves, hatches and/or other mechanisms that might need to be secured and monitored. Accordingly, other implementations are within the scope of the following claims.

What is claimed is:

1. A system comprising:
a shipping container having one or more doors, the doors having fixtures for securing the doors in a closed position;
a container monitoring device having a conductive cable for securing the one or more doors in the closed position, the cable being routed around the door fixtures to prevent opening of the container doors;
where the container monitoring device is configured to transmit a signal through the conductive cable and detect that the conductive cable has been cut based on the signal; and
where the conductive cable is configured to be reattachable to the container monitoring device after the conductive cable has been cut.

2. The system of claim 1, wherein the container monitoring device is configured to detect that the conductive cable has been cut when the signal is no longer detectable in the conductive cable.

3. The system of claim 1, wherein the container monitoring device includes a Rogowski coil for detecting that the signal is no longer being transmitted through the cable.

4. The system of claim 1, wherein the container monitoring device is configured to detect that the conductive cable has been cut by detecting a reflected signal.

5. The system of claim 1, wherein the container monitoring device is configured to detect that the conductive cable has been cut based on a detected change in a waveform corresponding to the signal.

6. The system of claim 1, wherein the signal is transmitted from an originating end of the conductive cable to a terminating end of the conductive cable; wherein the conductive cable is cut proximate to the terminating end and reattached to the container monitoring device at the cut in the conductive cable.

7. A system comprising:
a shipping container having one or more doors, the doors having fixtures for securing the doors in a closed position;
a container monitoring device affixed to the exterior of the shipping container;
one or more sensor pods located inside the shipping container, where the sensor pods are configured to receive measurements from one or more sensors and wirelessly transmit the sensor data to the container monitoring device; and
where the container monitoring device is configured to receive measurements from the sensor pods and generate events based on the measurements.

8. The system of claim 7, wherein at least one of the sensor pods includes a temperature sensor and wherein the at least one sensor pod is configured to transmit temperature sensor measurements to the container monitoring device.

9. The system of claim 7, wherein at least one of the sensor pods includes a humidity sensor and wherein the at least one sensor pod is configured to transmit humidity sensor measurements to the container monitoring device.

10. The system of claim 7, wherein at least one of the sensor pods includes a light sensor and wherein the at least one sensor pod is configured to transmit light intensity measurements to the container monitoring device.

11. The system of claim 7, wherein the sensor pods and the container monitoring device communicate over a wireless mesh network.

12. The system of claim 7, wherein the container monitoring device is configured to transmit the events to a server using a general packet radio service network.

13. The system of claim 7, wherein the sensor pods are associated with the container monitoring device and the container monitoring device is configured to detect when the container monitoring device is not able to communicate with one or more of the associated sensor pods.

14. A system comprising:
a shipping container having one or more doors, the doors having fixtures for securing the doors in a closed position; and
a monitoring device having a conductive cable for securing the one or more doors in the closed position, the cable being routed around the door fixtures to prevent opening of the container doors;
where the container monitoring device is configured to transmit a signal through the conductive cable and detect that the conductive cable has been cut based on the signal.

15. The system of claim 14, wherein the container monitoring device is configured to detect that the conductive cable has been cut by comparing a first signal transmitted through the conductive cable to a second signal transmitted through a conductive pathway internal to the container monitoring device.

16. The system of claim 14, wherein the container monitoring device is configured to detect that the conductive cable has been cut by comparing properties of a first signal measured at a first time to properties of a second signal measured at a second time that is later than the first time.

17. The system of claim 16, wherein the compared signal properties include phase or gain.

18. The system of claim 14, wherein the container monitoring device is configured to detect that the conductive cable has been cut by comparing electrical properties of the conductive cable measured at a first time to electrical properties of the conductive cable measured at a second time that is later than the first time.

19. The system of claim 18, wherein the compared electrical properties include impedance, conductance or capacitance of the conductive cable.

20. The system of claim 14, wherein the container monitoring device is configured to detect that the conductive cable has been cut by comparing radiated properties of the conductive cable measured at a first time to radiated properties of the conductive cable measured at a second time that is later than the first time.

21. The system of claim 20, wherein the compared radiated properties include magnetic field, magnetic flux, Lorentz force, Laplace force, or electromagnetic radiation.

22. A system comprising:
a device having an open position and a closed position, the device having one or more fixtures for securing the device in the closed position;
a container monitoring device having a conductive cable for securing the device in the closed position, the cable being routed around the device fixtures to prevent opening of the device;
where the container monitoring device is configured to transmit a signal through the conductive cable and detect that the conductive cable has been cut based on the signal; and
where the conductive cable is configured to be reattachable to the container monitoring device after the conductive cable has been cut.
